(19) United States
(12) Patent Application Publication
(10) Pub. No.: US 2014/0028671 A1
(43) Pub. Date: Jan. 30, 2014

(54) STEREO DISPLAY PANEL, APPARATUS FOR STEREO DISPLAYING, AND METHOD FOR DISPLAYING IMAGE

(71) Applicants: Jong Oh Lee, Siheung-si (KR); Gyo Hyun Lee, Siheung-si (KR)

(72) Inventors: Jong Oh Lee, Siheung-si (KR); Gyo Hyun Lee, Siheung-si (KR)

(21) Appl. No.: 14/111,517

(22) PCT Filed: Apr. 9, 2012
(86) PCT No.: PCT/KR2012/002682

§ 371 Date: Oct. 11, 2013

(30) Foreign Application Priority Data
Apr. 11, 2011 (KR) 10-2011-0033508
Jun. 8, 2011 (KR) 10-2011-0055041

(51) Int. Cl. G06T 15/08

(52) U.S. Cl. CPC G06T 15/08
USPC 345/419

(57) ABSTRACT

Provided are a stereo display panel, an apparatus for stereo display, and a method for displaying an image. The stereo display panel defines a plurality of unit pixels and implements a plurality of views. Here, q unit pixels adjacent to each other in a row direction form one unit row, and q is an integer. p unit rows adjacent to each other in a column direction implements the plurality of views, and p is an integer. When a product of the integer p and the integer q is n, the integer n is a multiple of 2. An image implemented in the stereo display panel includes z basic images and (n−z) compensation images.

### TECHNICAL FIELD

The present invention relates to a stereo display panel, an apparatus for stereo display, and a method for displaying an image.

### BACKGROUND ART

Three-dimensional image display technology is a technology that allows a user to feel a cubic effect by the binocular parallax in which a difference occurs between images of the left eye and the right eye. A method of viewing a three-dimensional image can be classified into a glass mode and a glassless mode. The glass mode has an inconvenience in that a user needs to wear glasses, and it may be difficult for a user to observe objects except stereoscopic images while wearing glasses. Accordingly, studies for glassless mode are being extensively conducted.

The glassless mode may be classified into a lenticular method using a cylindrical lens and a parallax barrier method using a light transmitting part and a light blocking part. In the lenticular method, since a lens is used, a distortion of an image may occur. On the other hand, the parallax barrier method has an advantage in that stereoscopic viewing is possible from different positions.

However, when a stereoscopic image of a multi-view is implemented using a parallax barrier method, a ratio of a light transmitting part is very low. That is, when n number of views are implemented, a ratio of a light transmitting part to a light blocking part becomes 1:(n−1) and thus a ratio of the light transmitting part inevitably becomes very low. Thus, when the ratio of the light transmitting part is lowered, a ratio of a portion of a display device where an image is displayed is reduced, and thus the resolution may be deteriorated.

Generally, since a stereo display panel fixedly represents a determined number of views, it is impossible to use contents different in the number of views, or a separate apparatus or process is needed to convert contents different in the number of views. Accordingly, there is a limitation in implementing images with different number of views using the stereo display apparatus.

### DISCLOSURE

### Technical Problem

The present invention provides a stereo display panel, an apparatus for stereo display, and a method for displaying an image, which can improve the resolution and can display images with different number of views.

### Technical Solution

In accordance with an aspect of the present invention, there is provided a stereo display panel defining a plurality of unit pixels and implementing a plurality of views, wherein: q unit pixels adjacent to each other in a row direction form one unit row, q being an integer; p unit rows adjacent to each other in a column direction implements the plurality of views, p being an integer; when a product of the integer p and the integer q is n, the integer n is a multiple of 2; and an image implemented in the stereo display panel includes z basic images and (n−z) compensation images.

The number of the compensation images corresponding to the basic images may be y, respectively, and the number y may be expressed as Equation (1) below.

y=(n−z)/z (1)

The z basic images may include a first basic image and a second basic image. The y compensation images may include a first compensation image corresponding to the first basic image and a second compensation image corresponding to the second basic image. The numbers of the first and second compensation images may be y, respectively. Also, the number y may be expressed as Equation (1) below.

y=(n−z)/z (1)

When the integer z is a sum of an integer (z1) and an integer (z2), the z basic images may include (z1) input images and (z2) auxiliary images.

The (z1) input images may include a first image, a second image, . . . , (z1)-th image, and the (z2) auxiliary images may include a second image, . . . , {(z1)−1}-th image.

The integer p may be 2. The q unit pixels adjacent to each other in the row direction may form a first unit row. The q unit pixels adjacent to the first unit row in the column direction and adjacent to each other in the row direction may form a second unit row. Also, the first unit row and the second unit row may implement the plurality of views.

In accordance with another aspect of the present invention, there is provided a stereo display panel defining a plurality of unit pixels and implementing a plurality of views, wherein: the plurality of views are implemented by n unit pixels, respectively, n being a multiple of 2; an image implemented in the stereo display panel includes z basic images and (n−z) compensation images; the number of compensation images corresponding to the basic images is y, respectively; and the number y is expressed as Equation (1) below.

Y=(n−z)/z (1)

In accordance with another aspect of the present invention, there is provided a stereo display apparatus including: a stereo display panel according to any one of claims 1 to 6; and a parallax barrier positioned at one surface of the stereo display panel.

The parallax barrier may include a plurality of light transmitting part and a plurality of light blocking part, and when assuming that a value obtained by subtracting 1 from q is m, one unit pixel corresponding to the light transmitting part and m unit pixels corresponding to the light blocking part in a row direction may be repeatedly disposed.

In accordance with another aspect of the present invention, there is provided an image display method of a stereo display panel defining a plurality of unit pixels and implementing a plurality of views, wherein: q unit pixels adjacent to each other in a row direction form one unit row, q being an integer; p unit rows adjacent to each other in a column direction implements the plurality of views, p being an integer; when a product of the integer p and the integer q is n, the integer n is a multiple of 2; and an image implemented in the stereo display panel includes z basic images and (n−z) compensation images.

The number of the compensation images corresponding to the basic images may be y, respectively, and the number y may be expressed as Equation (1) below.

y=(n−z)/z (1)

The z basic images may include a first basic image and a second basic image. The y compensation images may include a first compensation image corresponding to the first basic image and a second compensation image corresponding to the second basic image. The numbers of the first and second compensation images may be y, respectively. The number y may be expressed as Equation (1) below.

y=(n−z)/z (1)

After the first basic image and the first compensation image are projected, the second basic image and the second compensation image may be projected.

When the integer z is a sum of an integer (z1) and an integer (z2), the z basic images may include (z1) input images and (z2) auxiliary images.

The (z1) input images may include a first image, a second image, . . . , (z1)-th image, and the (z2) auxiliary images may include a second image, . . . , {(z1)−1}-th image.

After the input image and a compensation image corresponding thereto are projected, the auxiliary image and a compensation image corresponding thereto may be projected.

The integer p may be 2. The q unit pixels adjacent to each other in the row direction may form a first unit row. The q unit pixels adjacent to the first unit row in the column direction and adjacent to each other in the row direction may form a second unit row. Also, the first unit row and the second unit row may implement the plurality of views.

In accordance with another aspect of the present invention, there is provided an image displaying method of a stereo display panel defining a plurality of unit pixels and implementing a plurality of views, wherein: the plurality of views are implemented by n unit pixels, respectively, n being a multiple of 2; an image implemented in the stereo display panel includes z basic images and (n−z) compensation images; the number of compensation images corresponding to the basic images is y, respectively; and the number y is expressed as Equation (1) below.

Y=(n−z)/z (1)

### Advantageous Effects

In a stereoscopic display apparatus according to an exemplary embodiment of the present invention, even when implementing a multi-view of the same n number, the stereoscopic display apparatus is driven to increase a light transmitting part ratio in the parallax barrier and thus luminance and a resolution can be improved. In this case, in order to implement n views, when using the n number of unit pixels, by enabling n to be a multiple of 2 and by disposing the n number of unit pixels at two rows, a horizontal line can be prevented from occurring in an image implemented in a display panel Accordingly, the image quality and luminance can be improved.

Also, in the present embodiment, even when an image signal with z (smaller than n) views is inputted in a stereo display panel designed based on n unit pixels, an image implementation is enabled by (n−z) compensation signals. Accordingly, both three-dimensional and two-dimensional contents with different number of views can be implemented without a separate apparatus.

### BRIEF DESCRIPTION OF DRAWINGS

FIG. 1 is a cross-sectional view illustrating a stereo display apparatus according to an embodiment of the present invention.

FIG. 2 is a cross-sectional view illustrating a stereo display apparatus according to a modified embodiment of the present invention.

FIG. 3 is a flowchart illustrating an image displaying method using a stereo display apparatus according to an embodiment of the present invention.

FIG. 4 is a plan view illustrating unit pixels of a display panel and a light blocking part and a light transmitting part of a parallax barrier corresponding thereto according to an embodiment of the present invention.

FIG. 5 is a plan view illustrating unit pixels implementing a multi-view in a display panel and a light blocking part and a light transmitting part of a parallax barrier corresponding thereto according to an embodiment of the present invention.

FIG. 6 is a plan view illustrating unit pixels implementing a multi-view in a typical display panel and a light blocking part and a light transmitting part of a typical parallax barrier corresponding thereto.

FIG. 7 is a view illustrating an image sequence in an image displaying method according to an embodiment of the present invention.

FIG. 8 is a view illustrating an image distribution in a display panel according to an embodiment of the present invention.

FIG. 9 is a view illustrating an image distribution in a display panel according to another embodiment of the present invention.

FIG. 10 is a flowchart illustrating acquiring of z basic images in an image displaying method according to another embodiment of the present invention.

FIG. 11 is a view illustrating an image sequence in an image displaying method according to another embodiment of the present invention.

FIG. 12 is a view illustrating an image sequence in a typical image displaying method.

FIG. 13 is a plan view illustrating unit pixels implementing a multi-view in a display panel and a light blocking part and a light transmitting part of a parallax barrier corresponding thereto according to another embodiment of the present invention.

FIG. 14 is a cross-sectional view illustrating a stereo display apparatus according to another embodiment of the present invention.

### BEST MODES FOR CARRYING OUT THE INVENTION

Hereinafter, a stereo display apparatus and an image displaying method according to an embodiment of the present invention will be described in detail with reference to the accompanying drawings.

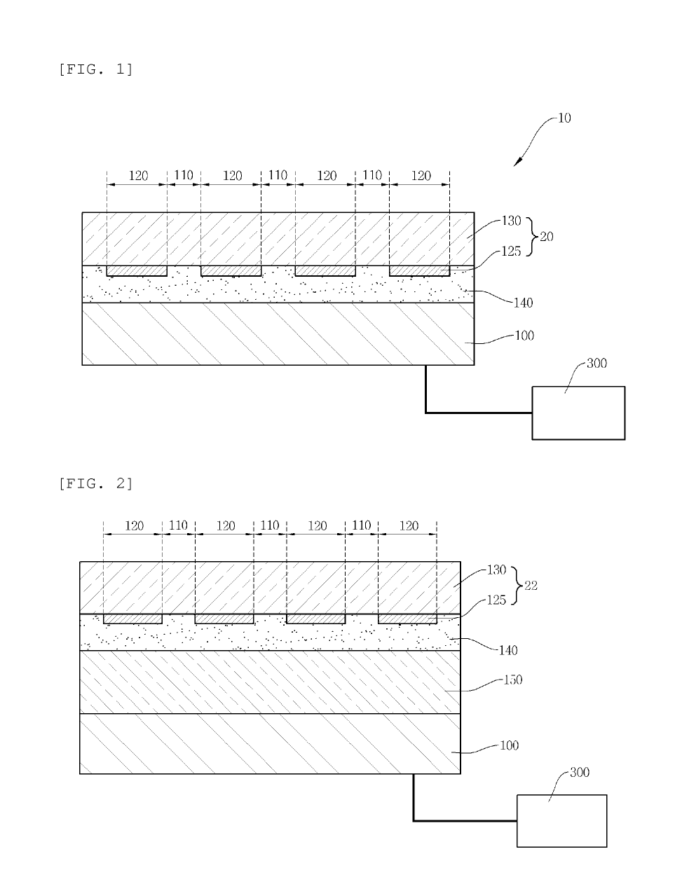

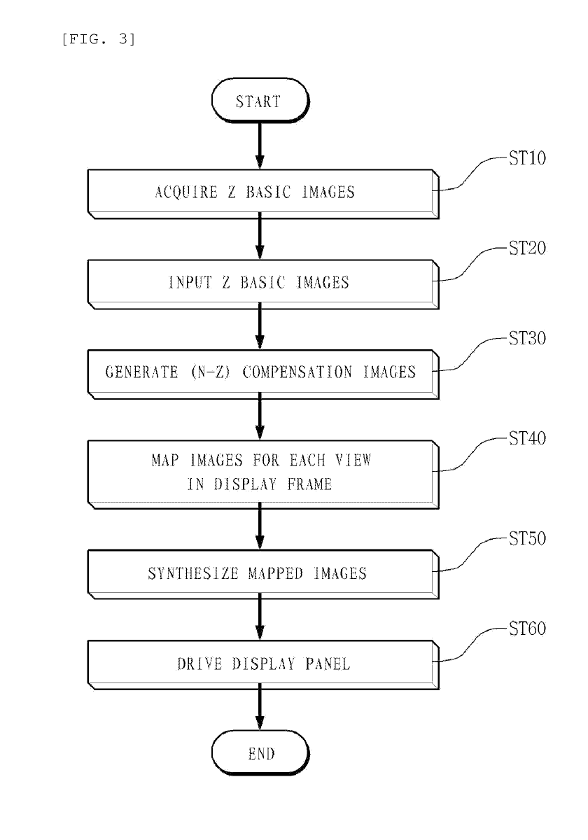

FIG. 1 is a cross-sectional view illustrating a stereo display apparatus according to an embodiment of the present invention. FIG. 2 is a cross-sectional view illustrating a stereo display apparatus according to a modified embodiment of the present invention.

Referring to FIG. 1, a stereo display apparatus 10 according to an embodiment of the present invention may include a display panel 100 defining a plurality of unit pixels (hereinafter, see 210 of FIG. 3) and implementing a multi-view, a driving part 300 for controlling the driving of the display panel 100, and a parallax barrier 20 disposed on one surface (more specifically, front surface) of the display panel 100.

For example, the display panel 100 may include a Liquid Crystal Display (LCD), a Plasma Display Panel (PDP), and a display panel using a Light Emitting Diode (LED). However, the present invention is not limited thereto, and various types of display panels may be used.

In the display panel 100, a plurality of unit pixels 210 may be defined in row and column directions. In this embodiment, a multi-view image may be implemented in the display panel 100. Hereinafter, the number of views of the display panel 100 will be assumed to be n for convenience of explanation. Here, n may be an integer greater than or equal to 2.

The driving part 300 may control the driving of the display panel 100, and may provide a multi-view image signal to the display panel 100 to implement a three-dimensional image by the multi-view.

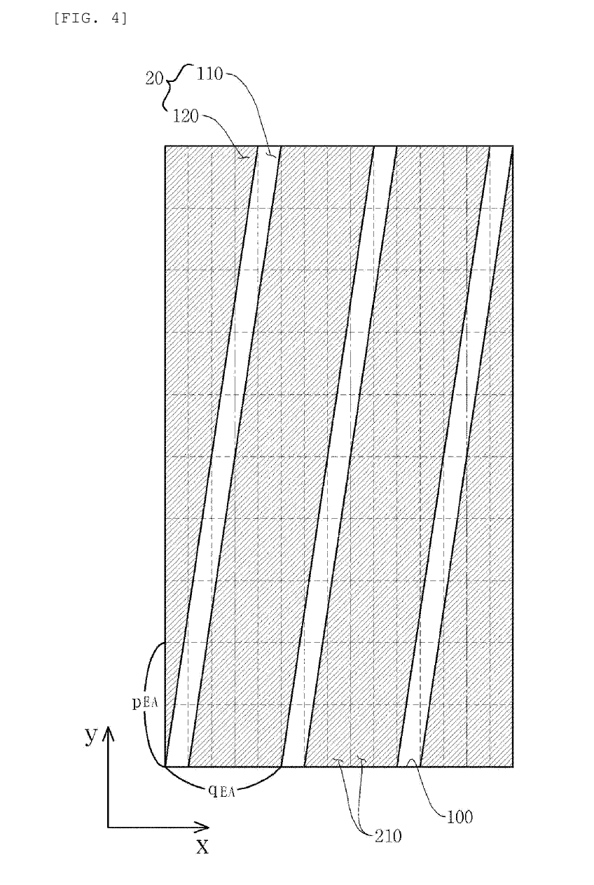

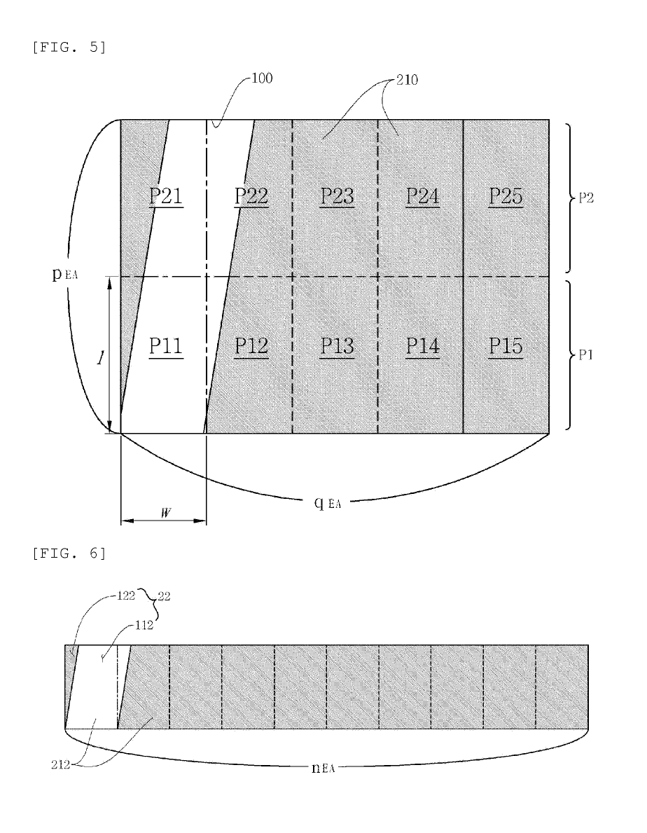

In this embodiment, the driving part 300 may allow a multi-view image to be implemented by the unit pixels 210 defined in multiple rows and columns. A detailed description thereof will be made later with reference to FIGS. 4 and 5. For reference, in a related art, a multi-view image is displayed in multiple columns of a single row.

The parallax barrier 20 disposed on the front surface of the display panel 100 may selectively transmit the multi-view image to form a parallax barrier such that an observer can see different images with both eyes. For this, the parallax barrier 20 may include a plurality of light transmitting parts 110 and a plurality of light blocking part 120 corresponding to the unit pixels 210 of the display panel 100, respectively.

More specifically, as shown in FIG. 1, the parallax barrier 20 may include a transparent substrate 130 and a barrier pattern 125 formed on the transparent substrate 130.

Here, the barrier pattern 125 may be formed by coating and drying an ultraviolet ink or a thermosetting ink and then performing a patterning process, but the present invention is not limited thereto. A portion where the barrier pattern 125 is formed may define the light blocking part 120, and the other portion where the barrier pattern 125 is not formed may define the light transmitting part 110. A two-dimensional layout of the light blocking part 120 and the light transmitting part 110 will be described in detail with reference to FIGS. 4 and 5.

The transparent substrate 130 may be a glass substrate. When a glass substrate is used as the transparent substrate 130, the transmittance may be high, allowing a separate substrate to be omitted. Accordingly, an image implemented on the display panel 100 may be allowed to be transmitted with a high transmittance without a limitation such as a distortion.

On the other hand, a typical parallax barrier is used by laminating patterned polymer films (e.g., polyethylene phthalate and polyethylene terephthalate (PET) films) on a tempered glass using an adhesive. Generally, the transmittance of the polymer film and the tempered glass is lower than the transmittance of typical glass, and thus a typical parallax barrier using the polymer film and the tempered glass inevitably has a significantly low transmittance. Also, a destructive interference may occur due to refractive indexes of polymer film, tempered glass and adhesive, and thus a moiré phenomenon may occur.

Thus, in this embodiment, since the transparent substrate 130 may be formed of a glass substrate, a high transmittance can be achieved without an image distortion. However, the present invention is not limited to the material of the transparent substrate 130, and various kinds of materials can be used for the transparent substrate 130.

The parallax barrier 20 may be fixedly attached to the front surface of the display panel 100 via an adhesive layer 140. The adhesive layer 140 may be formed of various materials, for example, an ultraviolet adhesive, a visible light adhesive, an infrared adhesive and a heat adhesive.

It is preferable that such a bonding layer 140 has a refractive index similar to that of the transparent substrate 130, and thus minimizes moiré and prevents Newton ring from occurring. For example, when the transparent substrate 130 is formed with a glass substrate, the bonding layer 140 may have a refractive index of about 1.48-1.54 similar to that of a glass substrate.

FIG. 1 illustrates that the parallax barrier 20 is formed with the transparent substrate 130 and the barrier pattern 125 formed on the transparent substrate 130. However, the present invention is not limited thereto.

Therefore, in a modified example, as shown in FIG. 2, a parallax barrier 22 may include a transparent substrate 130, a barrier pattern 125, a bonding layer 140 formed on the transparent substrate 130 and the barrier pattern 125, and a separate transparent substrate 150 bonded by the bonding layer 140. The above-described separate transparent substrate 150 may include the same material as that of the transparent substrate 130. In the present modified example, the parallax barrier 22 and the display panel 100 may be coupled by a bonding layer (not shown) or a fixed member (not shown). In addition, a parallax barrier having various sectional structures may be used.

A two-dimensional structure of the above-described parallax barrier 20 and an image displaying method in the display panel 100 in which the parallax barrier 20 is used will be described in detail with reference to FIGS. 3 to 10.

FIG. 3 is a flowchart illustrating an image displaying method using a stereo display apparatus according to an embodiment of the present invention.

Referring to FIG. 3, the image displaying method may include acquiring z basic images (ST10), inputting the z basic images (ST20), generating (n−z) compensation images (ST30), mapping images for each view in a display frame (ST40), synthesizing the mapped images (ST50), and driving a display panel (ST60).

Thus, in this embodiment, in order to implement a plurality of views in n unit pixels, n images are not used, but z basic images and (n−z) compensation images are used.

First, in the acquiring of the z basic images (ST10), z (z is smaller than n) basic images may be prepared. In this case, the present embodiment illustrates that different z (e.g., two) basic images are used.

Next, in the inputting of the z basic images (ST20), the z basic images may be inputted, and in the generating of the (n−z) compensation images (ST30), the (n−z) compensation images may be generated from the z basic images. For example, when the z basic images include first and second basic images, first and second compensation images corresponding thereto may be generated. In this case, the number of the first images and the number of the second images may be equal to each other.

That is, the numbers of the compensation images corresponding to the basic images, respectively, may be equal to each other, which can be expressed as y of Equation (1) below.

y=(n−z)/z (1)

For example, when n is 10 and z is 2, the total number of the compensation images is 8, the number of the compensation images corresponding to the basic images, respectively, becomes 4. The image displaying method of projecting such basic images and compensation images to the three-dimensional display panel will be described in detail later.

Next, in the mapping of the images for each view in the display frame (ST40), the image for each view may be mapped in a predetermined location of the display frame, and in the synthesizing of the mapped images (ST50), the mapped images may be synthesized to acquire a desired image. Next, in the driving of the display panel (ST60), a signal corresponding to the synthesized image may be provided to the display panel 100 to drive the display panel 100.

FIG. 4 is a plan view illustrating unit pixels of a display panel and a light blocking part and a light transmitting part of a parallax barrier corresponding thereto according to an embodiment of the present invention. FIG. 5 is a plan view illustrating unit pixels implementing a multi-view in a display panel and a light blocking part and a light transmitting part of a parallax barrier corresponding thereto according to an embodiment of the present invention.

Referring to the drawings, in the display panel 100 according to this embodiment, a plurality of unit pixels 210 are defined. More specifically, a plurality of unit pixels 210 are disposed while having a plurality of columns in a row direction (x-axis direction of the drawing) and having a plurality of rows in a column direction (y-axis direction of the drawing). Such unit pixels 210 include red color pixels that emit red color light, green color pixels that emit green color light, and blue color pixels that emit blue color light. For example, one red color pixel, one green color pixel, and one blue color pixel adjacent in a row direction may display an image by forming one pixel, but the present invention is not limited thereto. Therefore, it should be noted that one pixel can be formed by other color pixels except the red color pixel, the green color pixel, and the blue color pixel.

The display panel 100 according to this embodiment is not based on n unit pixels 120 disposed in one row or column, but is based on n unit pixels 120 disposed in a plurality of rows and columns. However, the present invention is not limited thereto.

More specifically, unit pixels of the q number adjacent in a row direction form one unit row. A plurality of views may be implemented by n unit pixels 210, i.e., unit pixels of the p number * the q number shown in FIG. 5, positioned at unit rows of the p number adjacent in a column direction. Here, n is an integer of 2 or more, p and q are integers that are divisors of n, and the product of p and q becomes n. More accurately, since the unit pixels 210 positioned by a plurality of columns and a plurality of rows are used and at least two rows and two columns need be provided, n is an integer of 4 or more.

For example, in FIGS. 4 and 5, 10 views may be implemented using two unit rows formed with five unit pixels adjacent in a row direction. That is, when using two of a unit row formed with adjacent 5 unit pixels in a row direction, total 10 unit pixels are formed and thus 10 views are implemented. Here, q becomes five, and p becomes 2. In the drawings, for example, the 10 view number is illustrated, but the present invention is not limited thereto. Therefore, the present invention may have various values of n, p, and q.

Here, as described above, n may be a multiple of 2, and p may be 2. Therefore, n views may be implemented with a first unit row (hereinafter, “odd number row”) 211 including unit pixels of the q number adjacent in a row direction and a second unit row (hereinafter, “even number row”) 212 adjacent to the odd number row and including unit pixels of the q number adjacent in a row direction. Thereby, by diffraction of light, a phenomenon in which a horizontal line occurs in an image implemented in the display panel 100 can be prevented.

More specifically, when n is the odd number, p and q are also the odd number, and in this case, due to diffraction of light, a horizontal line may occur in an image implemented in the display panel 100. When n is a multiple of 3, such a phenomenon may more remarkably occur.

For example, when 9 views are implemented with unit pixels of 3 columns and 3 rows, a horizontal line may occur. In consideration of this, in the present invention, by forming n in a multiple of 2 and forming p in 2, a horizontal line is minimized from occurring. Further, it is preferable that all of n, p, and q are not a multiple of 3.

In the parallax barrier 20 used for such a display panel 100, when viewing in a row direction, one unit pixel corresponding to the light transmitting part 110 and unit pixels of the m number corresponding to the light blocking part 120 are repeatedly disposed. Here, m is the number that subtracts 1 from q. In this way, when n views are implemented with columns of the q number and rows of the p number, a ratio of the light transmitting part 110 to the light blocking part 120 is 1:m (i.e., 1:(q−1)) and thus a ratio of the light blocking part 120 may be decreased and a ratio of the light transmitting part 110 may be increased. In this way, by increasing a ratio of the light transmitting part 110, there is a merit that luminance and a resolution may be increased.

For clearer description, this will be described with reference to FIGS. 5 and 6. FIG. 6 is a plan view illustrating unit pixels implementing a multi-view in a typical display panel and a light blocking part and a light transmitting part of a typical parallax barrier corresponding thereto.

In this embodiment, as shown in FIG. 5, when n is 10, p is 2, and q is 5, when viewing in a row direction from the parallax barrier 20, a ratio of the light transmitting part 110 to the light blocking part 120 is 1:4. That is, when implementing 10 views, in the parallax barrier 20, a ratio of the light transmitting part 110 to the light blocking part 120 is 1:4.

However, as shown in FIG. 6, typically, in order to implement n views, images of the n number are displayed in adjacent unit pixels 212 of the n number in one row, and when viewing in a row direction from a parallax barrier 22, a ratio of a light transmitting part 112 to a light blocking part 122 is 1:(n−1). For example, when implementing 10 views, in the parallax barrier 22, a ratio of the light transmitting part 112 to the light blocking part 122 is 1:9.

Therefore, in this embodiment, even while implementing a multi-view of the same number, a ratio of the light transmitting part 110 in the parallax barrier 20 can be enhanced and thus luminance and a resolution can be increased to correspond thereto. For example, as described above, when n is a multiple of 2 and p is 2, luminance and a resolution can be increased by the double or more.

In the drawing, for briefly describing, it is illustrated that the light transmitting part 110 and a unit pixel 210 have the same size, but the present invention is not limited thereto. Actually, a size of the light transmitting part 110 corresponding to each unit pixel 210 may be smaller than that of each unit pixel 210.

When the number of views is large rather than when the number of views is small, a size ratio of the light transmitting part 110 may be relatively enlarged. This is designed so that a wavelength of light passes to one unit pixel 210 with the constant number of times, and thus an interference phenomenon is minimized, and therefore a moiré phenomenon is minimized. In consideration of a process error together with this, a width ratio of the light transmitting part 110 to the light blocking part 120 may be 0.95:(m+0.05) to 1.33:(m−1.33). More preferably, a width ratio of the light transmitting part 110 to the light blocking part 120 may be 0.95:(m+0.05) to 1.2:(m−1.2).

In this embodiment, as the light transmitting part 110 is formed in a diagonal direction of the display panel 100, a multi-view image can be softly expressed. In this case, as described above, the parallax barrier 20 of this embodiment excellently enables a transmittance and a refractive index characteristic and thus a moiré phenomenon can be effectively prevented from occurring.

In this case, as described above, when a multi-view is implemented in unit pixels positioned at rows of the p number and columns of the q number, a slope of the light transmitting part 110 is larger than that of the typical light transmitting part 112. That is, when a width w of a unit pixel according to a row direction is A and a length l of a unit pixel according to a column direction is B, a slope C of the light transmitting part 110 is theoretically represented by Equation (2).

C=(p*B)/A (2)

Actually, when it is considered that an error may exist, a slope C of the light transmitting part 110 is represented by Equation (3).

0.95*{(p*B)/A}≦C≦1.05*{(p*B/A)} (3)

In consideration of a length l and a width w of a commercialized unit pixel, a slope of the light transmitting part 110 may be 79° to 82°.

However, as shown in FIG. 6, in the related art in which unit pixels for implementing n views are positioned at one row, a slope of the light transmitting part 112 is a value obtained by dividing B by A. Therefore, a slope of the light transmitting part 112 of the related art is much smaller than that of the light transmitting part 110 of this embodiment. In this way, in this embodiment, by enabling a slope of the light transmitting part 110 to be larger than that of the related art, a ratio of the light transmitting part 110 may be relatively increased.

As described above, the display panel 100 according to this embodiment basically implements n views, but may display contents with z (smaller than n) input images. The image display method for this will be described in more detail with reference to FIGS. 7 to 9.

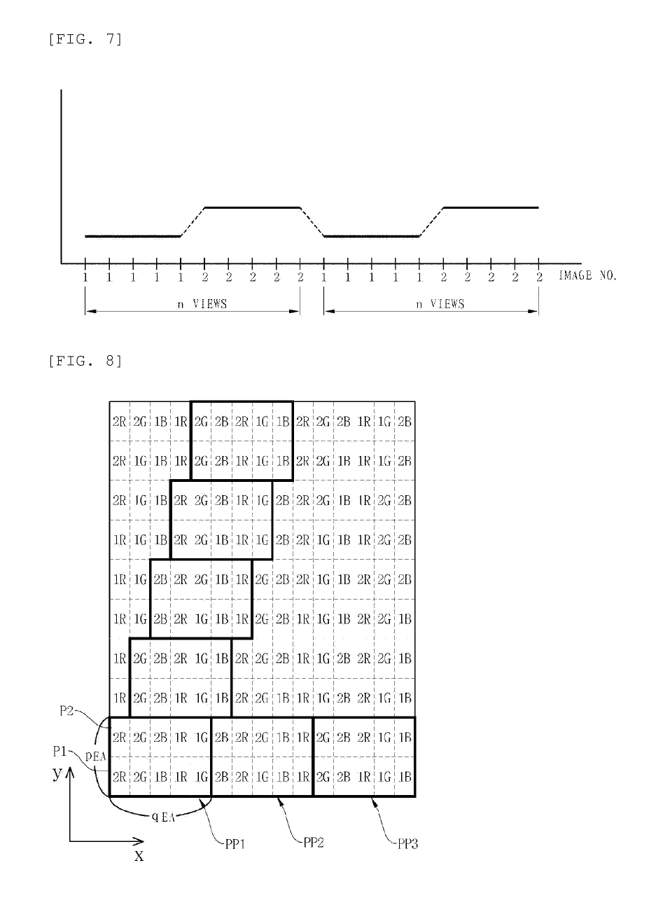

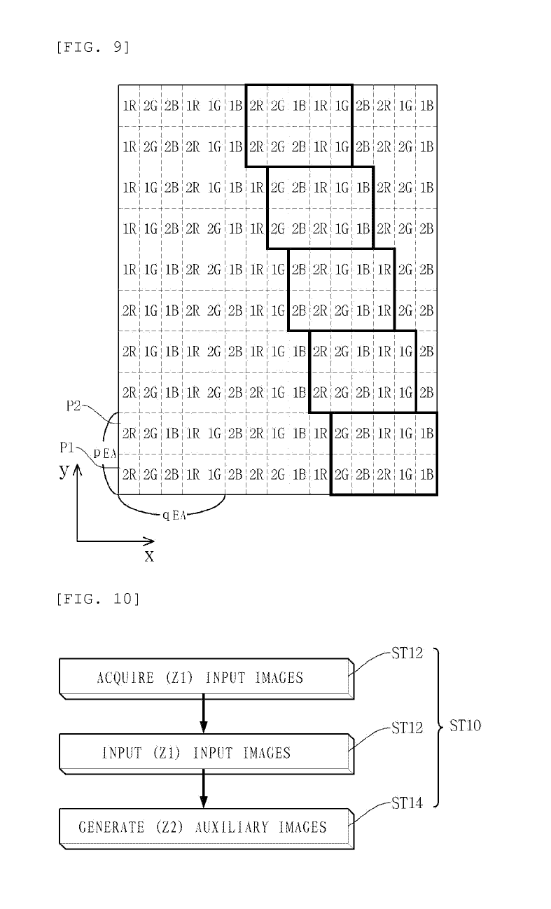

FIG. 7 is a view illustrating an image sequence in an image displaying method according to an embodiment of the present invention. FIG. 8 is a view illustrating an image distribution in a display panel according to an embodiment of the present invention, and FIG. 9 is a view illustrating an image distribution in a display panel according to another embodiment of the present invention.

In this embodiment, after basic images and compensation images corresponding to each other in n unit pixels 210 are all projected, the driving part 300 may allow the basic images and the compensation images corresponding to each other to be projected. A more detailed description thereof will be made with reference to FIG. 7.

For example, a case where n is 10 and z is 2 (i.e., including the first basic image and the second basic image as the basic image) will be exemplified. The first compensation image corresponding to the first basic image and the second compensation image corresponding to the second basic image may be generated. The total number of the compensation images may become (n−z), i.e., 8. In this case, according to the above-mentioned Equation (1), the number of first compensation images may become 4, and the number of second compensation images may become 4.

Assuming that the first basic image is the first image, the four first compensation images corresponding thereto may become the first images. Similarly, assuming that the second basic image is the second image, the four second compensation images corresponding thereto may become the second images. Then, a total of 5 first images and a total of 5 second images may be provided.

Thus, even when an image signal with z (smaller than n) views is inputted in a stereo display panel 10 designed based on n unit pixels implementing a plurality of views, an image implementation is enabled in the display panel 100. Accordingly, both three-dimensional and two-dimensional contents with different number of views can be displayed in the display panel 100 without a separate apparatus.

In this case, as shown in FIG. 7, the driving part (see 300 of FIG. 1) may allow the second basic image and the second compensation image corresponding to the second images to be projected by the parallax barrier 20 after the first basic image and the first compensation image corresponding to the first images are all projected. When this method is used, images can be smoothly represented such that a user cannot feel a boundary between views.

For the projection like FIG. 7, images may be projected to the display panel 100 as shown in FIG. 8. For clearer description, FIG. 5 will be referred.

That is, as shown in FIG. 8, the first basic image and the first auxiliary image (i.e., five first images) may be positioned at the 15 pixel P15, the 25 pixel P25, the 14 pixel P14, the 24 pixel P24, and the 13 pixel P13 of the parallax barrier 20, and the second basic image and the second auxiliary image (i.e., five second images) may be positioned at the 23 pixel P23, the 12 pixel P12, the 22 pixel P22, the 11 pixel P11, and the 21 pixel P21 of the parallax barrier 20. Then, the first, first, first, first, first, second, second, second, second, and second images may be sequentially viewed by a user via the parallax barrier 20. In this case, 10 unit pixels PP designed to implement n views may have an oblique form shifted to the right by one unit pixel while advancing upward.

However, the present invention is not limited thereto, and as shown in FIG. 9, 10 unit pixels PP for implementing views may have an oblique form shifted to the left by one unit pixel while advancing upward. In this case, the first basic image and the first auxiliary image may be positioned at the 15 pixel P15, the 25 pixel P25, the 14 pixel P14, the 24 pixel P24, and the 23 pixel P23 of the parallax barrier 20, and the second basic image and the second auxiliary image may be positioned at the 13 pixel P13, the 12 pixel P12, the 22 pixel P22, the 11 pixel P11, and the 21 pixel P21 of the parallax barrier 20.

Also, when representing red, green and blue, red, green and blue may be alternately positioned in a row direction of the unit rows constituting the 10 unit pixels PP. Thus, red, green, and blue images of the images for each view may all be provided in three of 10 unit pixels PP adjacent to each other.

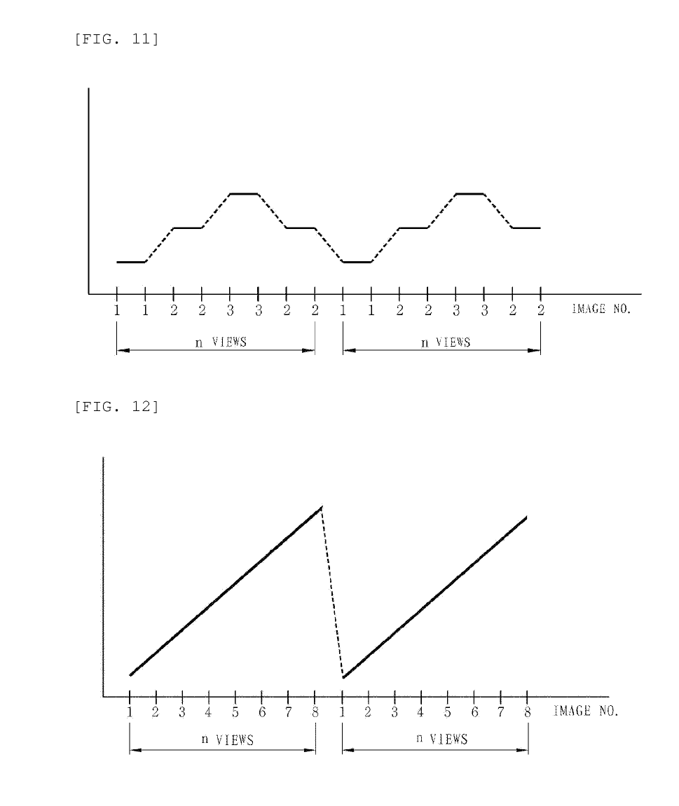

The present embodiment illustrates that different z (e.g., two) basic images are used as the basic images. However, the present invention is not limited thereto, and z1 input images and z2 auxiliary images may also be used as the basic images, which will be described with reference to FIGS. 10 and 11.

FIG. 10 is a flowchart illustrating acquiring of z basic images in an image displaying method according to another embodiment of the present invention.

Since this embodiment differs from the previous embodiment only in the acquiring of the z basic images (ST10) except the other steps, a description of the other steps will be omitted, and only the acquiring of the z basic images (ST10) will be described in detail.

In this embodiment, as shown in FIG. 10, the image displaying method may include acquiring z basic images (ST10), acquiring (z1) input images (ST12), inputting (z2) input images (ST14), and generating (z2) auxiliary images (ST16). Here, z is the sum of (z1) and (z2).

First, in the acquiring of the (z1) input images (ST12), (z1) (z1 is smaller than n and z) input images may be extracted. In this embodiment, since only (z1) (z1 is smaller than n and z) input images are extracted while implementing n views, the time taken to extract the input images can be reduced.

Next, in the inputting of the (z1) input images (ST14), the (z1) input images extracted may be inputted, and in the generating of the (z2) auxiliary images (ST16), the (z2) auxiliary images may be generated from the (z1) input images.

In this case, the (z1) input images may include a first image, a second image, . . . , a (z1)-th image, and the (z2) auxiliary images may include a second image, . . . , {(z1)−1}-th image.

Then, when an image of n views is implemented, the boundary of view can be reduced, providing a smooth image. A detailed description thereof will be made with reference to FIGS. 11 and 12.

FIG. 11 is a view illustrating an image sequence in an image displaying method according to another embodiment of the present invention. FIG. 12 is a view illustrating an image sequence in a typical image displaying method.

As an example, although n, z, and (z1) are illustrated as 8, 4 (four basic images), and 3 (three input images), respectively, the present invention is not limited thereto. Accordingly, n may vary, and particularly, n may be a multiple of 2.

In this embodiment, (z1) input images may include the first basic image that is the first image, the second basic image that is the second image, and the third basic image that is the third image. When the first to third basic images are inputted, a z2 (i.e., one) auxiliary image corresponding to the second image may be generated as the fourth basic image.

The first to fourth compensation images may be generated one by one corresponding to the first to fourth basic images, respectively. More accurately, the first compensation image becomes the first image, and the second compensation image becomes the second image. Also, the third compensation image becomes the third image, and the fourth compensation image becomes the second image.

The driving part 300 may allow the fourth basic image that is an auxiliary image and the fourth auxiliary image corresponding thereto to be projected after the first to third basic image that are the input images and the first to third compensation images corresponding thereto are projected. Accordingly, the first basic and compensation images (two first images), the second basic and compensation images (two second images), the third basic and compensation images (two third images), and the fourth basic and compensation images (two second images) may be sequentially projected. That is, on the whole, the image sequence may become the first, first, second, second, third, third, second, second, first, first, second, second, third, third, second, and second images. Thus, a portion with a significant parallax may not occur. Accordingly, a user may not feel the boundary between views, and the images may be recognized as smooth.

On the other hand, referring to FIG. 12, in similar 8 views in a related art, the first, second, third, fourth, fifth, sixth, seventh, and eighth images are sequentially projected, and then the first, second, third, fourth, fifth, sixth, seventh, and eighth images are sequentially projected. On the whole, since the first, second, third, fourth, fifth, sixth, seventh, eighth, first, second, third, fourth, fifth, sixth, seventh, and eighth images are sequentially projected, a user feels a significant parallax at the boundary of the eighth image and the first image. Accordingly, a user feels inconvenience due to the boundary of views.

That is, in this embodiment, a user may not feel the boundary between views and images may be recognized as smooth, using the z input images and the y compensation images.

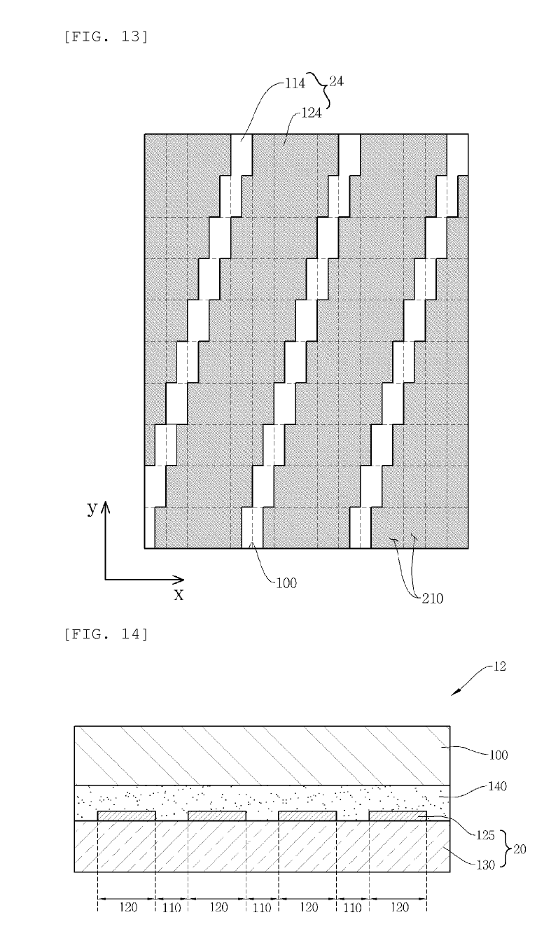

In the above-described description and drawings, it was illustrated that a boundary line of the light transmitting part 110 has an oblique form. However, the present invention is not limited thereto and as shown in FIG. 13, in a parallax barrier 24, at least a portion of a boundary line of a light blocking part 124 and a light transmitting part 114 may be formed in a diagonal direction of the display panel 100 while having a stair shape following a boundary of the unit pixels 210. In more detail, in one row, a boundary line of the light transmitting part 114 substantially corresponds with a boundary line of the unit pixels 210, and in another row adjacent thereto, a boundary line of the light transmitting part 114 substantially corresponds with a virtual center line of the unit pixels 210. A boundary of a multi-view image is cleared by the light transmitting part 114 having such a shape and thus a clear image can be implemented.

The present invention is not limited thereto and a light transmitting part of various shapes may be formed.

Further, in a passive light emitting stereoscopic display apparatus 12 using a backlight unit (not shown), a parallax barrier 20 may be positioned at a rear surface of a display panel 100, as shown in FIG. 14. In this case, a width of a light transmitting part 110 of the parallax barrier 20 may be formed larger than that of a unit pixel. Thereby, because a barrier line may not be seen to a user, the user's negative feeling that may occur by the barrier line may be removed.

The above-described characteristics, structures, and effects are included in at least an exemplary embodiment of the present invention and are not limited only to one exemplary embodiment. Furthermore, characteristics, structures, and effects illustrated in each exemplary embodiment may be combined or deformed, and performed in other exemplary embodiments by a person of ordinary skill in the art to which exemplary embodiments belong. Therefore, it should be analyzed that contents related to such a combination and deformation are included in the scope of the present invention.

1. A stereo display panel defining a plurality of unit pixels and implementing a plurality of views, wherein:
q unit pixels adjacent to each other in a row direction form one unit row, q being an integer;
p unit rows adjacent to each other in a column direction implements the plurality of views, p being an integer;
when a product of the integer p and the integer q is n, the integer n is a multiple of 2; and
an image implemented in the stereo display panel comprises z basic images and (n−z) compensation images.

2. The stereo display panel of claim 1, wherein the number of the compensation images corresponding to the basic images is y, respectively, and the number y is expressed as
y=(n−z)/z (1).

3. The stereo display panel of claim 1, wherein:
the z basic images comprise a first basic image and a second basic image;
the y compensation images comprise a first compensation image corresponding to the first basic image and a second compensation image corresponding to the second basic image;
the numbers of the first and second compensation images are y, respectively; and
the number y is expressed as
y=(n−z)/z (1).

4. The stereo display panel of claim 1, wherein when the integer z is a sum of an integer (z1) and an integer (z2), the z basic images comprise (z1) input images and (z2) auxiliary images.

5. The stereo display panel of claim 4, wherein the (z1) input images comprise a first image, a second image, . . . , (z1)-th image, and the (z2) auxiliary images comprise a second image, . . . , {(z1)−1}-th image.

6. The stereo display panel of claim 1, wherein:
the integer p is 2;
the q unit pixels adjacent to each other in the row direction form a first unit row;
the q unit pixels adjacent to the first unit row in the column direction and adjacent to each other in the row direction form a second unit row; and
the first unit row and the second unit row implements the plurality of views.

7. A stereo display panel defining a plurality of unit pixels and implementing a plurality of views, wherein:
the plurality of views are implemented by n unit pixels, respectively, n being a multiple of 2;
an image implemented in the stereo display panel comprises z basic images and (n−z) compensation images;
the number of compensation images corresponding to the basic images is y, respectively; and
the number y is expressed as
y=(n−z)/z (1).

8. A stereo display apparatus comprising:
a stereo display panel according to claim 1; and
a parallax barrier positioned at one surface of the stereo display panel.

9. The stereo display apparatus of claim 8, wherein the parallax barrier comprises a plurality of light transmitting part and a plurality of light blocking part, and when assuming that a value obtained by subtracting 1 from q is m, one unit pixel corresponding to the light transmitting part and m unit pixels corresponding to the light blocking part in a row direction are repeatedly disposed.

10. An image display method of a stereo display panel defining a plurality of unit pixels and implementing a plurality of views, wherein:
q unit pixels adjacent to each other in a row direction form one unit row, q being an integer;
p unit rows adjacent to each other in a column direction implements the plurality of views, p being an integer;
when a product of the integer p and the integer q is n, the integer n is a multiple of 2; and
an image implemented in the stereo display panel comprises z basic images and (n−z) compensation images.

11. The image displaying method of claim 10, wherein the number of the compensation images corresponding to the basic images is y, respectively, and the number y is expressed as
y=(n−z)/z (1).

12. The image displaying method of claim 10, wherein:
the z basic images comprise a first basic image and a second basic image;
the y compensation images comprise a first compensation image corresponding to the first basic image and a second compensation image corresponding to the second basic image;
the numbers of the first and second compensation images are y, respectively; and
the number y is expressed as
y=(n−z)/z (1).

13. The image displaying method of claim 12, wherein after the first basic image and the first compensation image are projected, the second basic image and the second compensation image are projected.

14. The image displaying method of claim 10, wherein when the integer z is a sum of an integer (z1) and an integer (z2), the z basic images comprise (z1) input images and (z2) auxiliary images.

15. The image displaying method of claim 14, wherein the (z1) input images comprise a first image, a second image, . . . , (z1)-th image, and the (z2) auxiliary images comprise a second image, . . . , {(z1)−1}-th image.

16. The image displaying method of claim 14, wherein after the input image and a compensation image corresponding thereto are projected, the auxiliary image and a compensation image corresponding thereto are projected.

17. The image displaying method of claim 10, wherein:
the integer p is 2;
the q unit pixels adjacent to each other in the row direction form a first unit row;
the q unit pixels adjacent to the first unit row in the column direction and adjacent to each other in the row direction form a second unit row; and
the first unit row and the second unit row implements the plurality of views.

18. An image displaying method of a stereo display panel defining a plurality of unit pixels and implementing a plurality of views, wherein:
the plurality of views are implemented by n unit pixels, n being an integer;
an image implemented in the stereo display panel comprises z basic images and (n−z) compensation images;
the number of compensation images corresponding to the basic images is y, respectively; and
the number y is expressed as
y=(n−z)/z (1).

19. A stereo display apparatus comprising:
a stereo display panel according to claim 2; and
a parallax barrier positioned at one surface of the stereo display panel.

20. A stereo display apparatus comprising:
a stereo display panel according to claim 3; and
a parallax barrier positioned at one surface of the stereo display panel.
